(19) United States
(12) Patent Application Publication
(10) Pub. No.: US 2016/0350700 A1
(43) Pub. Date: Dec. 1, 2016

(54) Project Management System For Integrated Project Schedules

(71) Applicant: Moca Systems, Inc., Newton, MA (US)

(72) Inventors: Daniel L. Leary, New Ipswich, NH (US); Richard K. Ware, Manhearst, MA (US); David W. Rolin, Carolina, RI (US); Jason A. Warlikowski, Newton, MA (US); Douglas B. Toland, Marlboro, MA (US); Mary-Anne G. Wolf, North Billerica, MA (US); Michael N. Carr, Wilmington, MA (US); Anne E. F. Alvarado, Newton, MA (US)

(73) Assignee: Moca Systems, Inc., Newton, MA (US)

(21) Appl. No.: 15/232,112

(22) Filed: Aug. 9, 2016

Related U.S. Application Data
(62) Division of application No. 12/538,537, filed on Aug. 10, 2009, now abandoned.

(51) Int. Cl. G06Q 10/06; G06Q 10/10

(52) U.S. Cl. CPC G06Q 10/063118; G06Q 10/06313; G06Q 10/06314; G06Q 10/1095; G06Q 10/067

(57) ABSTRACT

A simulation system and technique for simulating a project is described. The simulation system includes a work detail database having stored therein a plurality of attributes for the project, and a schedule generator coupled to receive information from the work detail database and having a push processor and a pull processor coupled thereto. The push and pull processors utilize different techniques/methodologies to establish dates and activities in a schedule produced by the schedule generator.

### CROSS-REFERENCE TO RELATED APPLICATIONS

This is a DIVISIONAL application of U.S. patent application Ser. No. 12/538,537 (filed Aug. 10, 2009) (the “'537 application”), which is incorporated by reference here in its entirety. This application claims benefit of the filing date of the '537 application under 35 U.S.C. §121 or under any other applicable law.

### STATEMENT REGARDING FEDERALLY SPONSORED RESEARCH

Not applicable.

### FIELD OF THE INVENTION

This invention relates generally to project management systems and more particularly to a method and apparatus for generating detailed integrated project schedules.

### BACKGROUND OF THE INVENTION

As is known in the art, a project planning technique is a technique that can be used to assemble a project plan (e.g. for a construction project). Some well-known project planning techniques include a dependency structure matrix (DSM), a critical path method (CPM), a precedence diagram method (PDM), a concurrent engineering technique, a critical chain technique, an overlapping framework technique, various system dynamics techniques, a simulation language for alternative modeling technique (SLAM), a graphical evaluation and review technique (GERT), a queue graphical evaluation and review technique (Q-GERT), and a program evaluation and review technique (PERT). Such conventional project planning techniques are thus used to plan and control projects.

Of the above techniques, CPM, PDM, PERT, and GERT will be recognized to be the most common project planning techniques. Such project planning techniques provide a model of a project plan having activities and time relationship linkages between the activities. Software systems implementing one or more of these prior techniques include Primavera Project Planner and Microsoft Project and CACI SimProcess.

Using these prior project planning techniques and systems it is difficult or impossible to reuse most of the project planning logic of one project when constructing a project plan for a second project. This logic includes repeating patterns of predecessor-successor relationships, rules governing the sequencing of work flow, and rules or heuristics for deciding how to make assignments of resources to activities. The difficulty stems largely from the fact that prior project planning techniques and systems require the project plan to be assembled by the user in “bottom-up” fashion, beginning with a description of each of the individual activities in the project including resource assignments and activity durations. Individual predecessor-successor relationships are then expressed in the prior systems between pairs of individual activities, with little or no facility for expressing patterns of predecessor-successor relationships among collections of activities. Once the user has specified this level of detailed data, the system can generate a project schedule by assigning start and finish dates to the individual project activities

Not only is it difficult to reuse the project planning logic of one project in another similar or dissimilar project, it is also usually cost prohibitive to develop multiple detailed and accurate project plans that might be applicable to a single complex project. Therefore detailed project plans are not often used with prior systems to help evaluate multiple possible alternative implementations of a project, nor to evaluate different alternative means and methods of executing the project, nor to evaluate multiple possible outcomes of a project at various decision points during the course of the project.

### SUMMARY OF THE INVENTION

Thus, in accordance with the concepts, systems and techniques described herein, it has been recognized that it would be desirable to provide a system and technique for computing a schedule for a project utilizing a system and technique capable of accommodating changes in data, precedence and other project attributes (e.g. such as construction attributes) and providing an appropriate schedule which reflects such changes.

In accordance with the present concepts described herein, a simulation system for simulating a project (e.g. such as a construction project) includes a work details table having a user-defined number of columns and having stored therein a plurality of attributes for the project, a schedule generator coupled to receive information from the database and to generate one or more schedules, a pull processor coupled to the schedule generator, said pull processor for scheduling activities by a “just-in-time” (or “JIT”) process which satisfies specific activity completion constraints, and a push processor coupled to the schedule generator, said push processor for scheduling resource constrained activities by means of a simulation model with specific resource availability, precedence, and priority constraints.

With this particular arrangement, a system and technique for computing a schedule for a project by describing a set of allowable resource level rules, a set of precedence rules, and work detail activities to be done with what quantities of effort required by which resources, but without specifying the duration and number of resources engaged in each such quantity of activity and without specifying the individual precedence relationships between any two such activities is provided.

By utilizing a work details table having a variable and user-defined number of columns, the system allows data-driven multidimensional organization of project data. This allows each project to utilize a work details table tailored for that specific project.

The push processor utilizes one technique, namely a simulation processor which executes a simulation model, to determine the schedule (start and finish times) for a subset of the project activities while the pull processor allows the remaining project activities to be scheduled by another technique, namely a just-in-time scheduling process. Thus, the system utilizes two different techniques for scheduling activities in the project. Which technique applies to a given activity is included in the precedence representation. The system also allows changing of precedence constraints and attributes utilizing a precedence editor. A precedence constraint might specify that one activity precedes another. An attribute of that precedence constraint might further specify that the constraint is of type Finish-Start (FS) meaning that the finish of the one activity (i.e. the point in time at which the one activity is considered finished) precedes the start of the other activity (i.e. the point in time at which the other activity is considered to begin). Another attribute might specify that a lag of a certain period of time (e.g. two days) occurs between the finish of the one activity and the start of the other.

In accordance with a further aspect of the concepts described herein, a method for generating a project schedule in response to a given set of project data, resource limits, resource calendars, and precedence is described. The technique uses two different types of data flow operators in a discrete event simulation model. One data flow operator is a work detail actor (WDA) and one data flow operator is a precedence actor (PA). The PA operator tracks satisfaction of precedence constraints and the WDA operator models the allocation of resources to a specific work detail and the scheduling of the work detail onset and completion. The WDA schedules the allocation of resources to the work detail in conjunction with a Resource Manager that associates with each work detail a calendar of available resource work days and work hours. Different calendars may be associated with different work details and hence with different WDAs.

With this particular arrangement, an entire simulation model is constructed from information stored in the work detail table (WDT) and the precedence table. Use of a user-defined WDT and multiple data flow operators (e.g. WDAs and PAs) allows the simulation model to be generated from the project data (vs. the prior art technique in which a fixed simulation model is supplied and the data must conform to it).

### BRIEF DESCRIPTION OF THE DRAWINGS

The foregoing features of this invention, as well as the invention itself, may be more fully understood from the following description of the drawings in which:

FIG. 1 is a block diagram of a simulation system which may be used to simulate work on a variety of different projects including but not limited to construction projects;

FIG. 1A is an exemplary work details table having stored therein information related to the project being simulated;

FIG. 1B is an exemplary work details table having stored therein information related to the project being simulated;

FIG. 1C is an exemplary crew composition table;

FIG. 2 is an exemplary precedence graph having a push portion and a pull portion;

FIG. 2A is a screen shot of an exemplary user-generated precedence graph;

FIG. 3 is an exemplary data flow model;

FIG. 4 is an exemplary data flow model;

FIG. 5 is an exemplary data flow model;

FIG. 5A is an exemplary work details table (WDT) for the example project described in conjunction with FIGS. 5-7;

FIG. 5B is an exemplary Gantt chart of a project schedule;

FIG. 6 is a block diagram illustrating structures to be built during a construction project;

FIG. 7 is an exemplary data flow model;

FIG. 8 is a flow diagram illustrating a process for scheduling a pull event;

FIG. 9 is an exemplary precedence graph;

FIGS. 10 and 11 are a diagrammatic representation of a portion of a schedule required to satisfy precedence defined by the precedence graph of FIG. 9;

FIG. 12 is an exemplary precedence graph having pull scheduled events;

FIG. 13 is a diagrammatic representation of a portion of a schedule required to satisfy precedence defined by the precedence graph of FIG. 12;

FIG. 14 is an exemplary precedence graph having push and pull scheduled events; and

FIG. 15 is a diagrammatic representation of a portion of a schedule required to satisfy precedence defined by the precedence graph of FIG. 14.

### DESCRIPTION OF THE PREFERRED EMBODIMENTS

Before describing the various embodiments of the invention, some introductory concepts and terminology are explained.

Described herein is a system and technique for generating a schedule for a project by specifying resource levels, precedence rules, activity and effort to be done but without specifying the duration of each activity to be done. This is accomplished via the use of a database comprising a plurality of dimensional columns and a plurality of measure columns.

Reference is made herein to simulation of a construction project. It should be appreciated, however, that such reference is made only to promote clarity in the text. The description of the broad concepts, systems and techniques described herein find use in a wide variety of applications and projects including, but not limited to any type of application and/or project which has a large number of components and complexities including but not limited to engineering projects, civil works, aerospace, government, IT, communications, telecommunications, individualized manufacturing, oil, gas, utilities, professional services, consulting, manufacturing, requisition, verification, inspection, new product development, demolition, and implementation of new services.

As used herein, the term “effort” is distinguished from the term “duration” in that effort is a measure of an amount of work to be done, while duration is a measure of an elapsed time from the beginning of work to the end of work. For example, ten man-hours of effort can be accomplished by ten men in one hour of duration, or by one man in ten hours duration. Any one of the three variables (i.e. effort, duration, and resources-busy) can be solved by knowing the other two (i.e. effort=resources-busy multiplied by duration). Thus, a value for effort may be computed as a product of a value for resources-busy and a value for duration.

It should also be appreciated that, in the context of a construction project, the term “schedule” means the beginning and end times for each of a (typically large) number of different activities as well as a project duration. The term schedule can also include, but is not limited to, the levels of resources busy (as opposed to available), material cost, and other attributes related to activities, by time and activity.

The term “activities” refers to tasks or actions. In a construction project, actions can be items such as “frame walls,” “hang sheet rock,” etc. Activities are associated with an amount of work to be done. The phrase “Frame walls” is an activity type, but activity values (also referred to as data or tokens) which are input to the system are effort quantities of an activity, For example, frame walls in room 23 for ten crew-hours (together with other possible attributes of the activity), frame walls in room 24 for twelve crew-hours (together with other possible attributes of the activity), hang sheet rock in room 23 for eight crew-hours (together with other possible attributes of the activity), etc.

The phrase “resource levels” refers to items such as the number of plumbers available on a given day or for a given period of time. Available and busy resource levels are distinguished, the former being the number (or amount) or a particular resource that could be busy if work was available for them, the latter being the number of resources (not exceeding the available number of resources) that are actually engaged in work. A “resource limit” is a rule provided by the user which limits the number of resources that are allowed to be busy on activities which meet specific constraints included in the resource limit. For instance a resource limit of ten plumbers on Floor 1 expresses the rule that at most ten plumber resources can be busy at any time with activities which occur on Floor 1.

As used herein the term “constraint” refers to logical constraints.

As used herein the terms “attributes” refers to a set of properties associated with a thing. For example, work details and precedence relationships are two attributes of a construction project. The attributes of a precedence relationship, for example, include whether its type is finish-to-start (FS), start-to-start (SS), or partial-to-start (PS) and whether it includes lag or not. Material cost and crew hours are two attributes related to activities. Numerous other examples also exist.

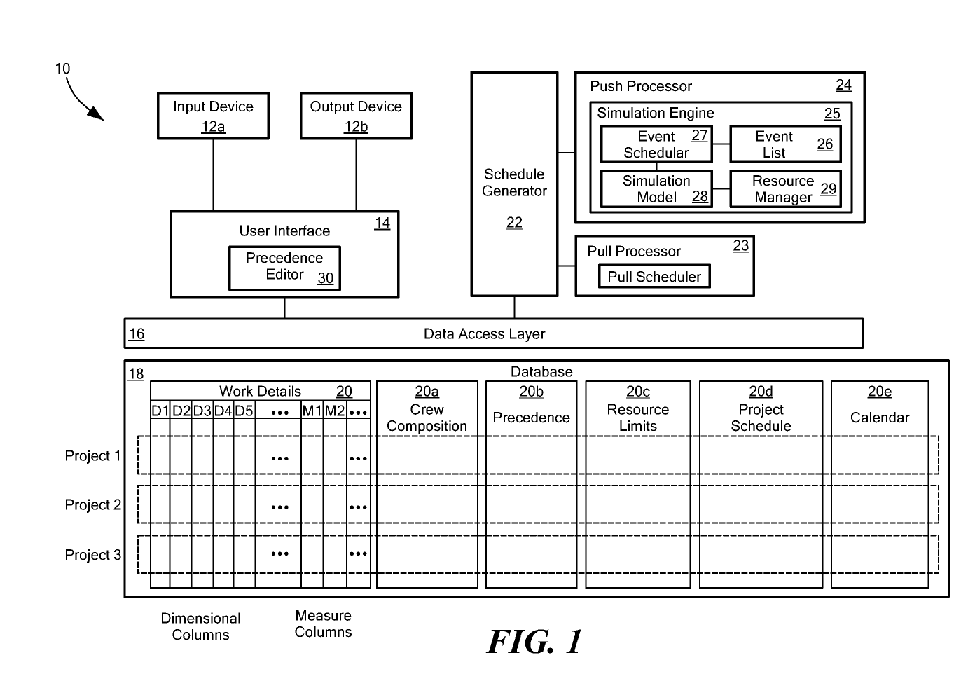

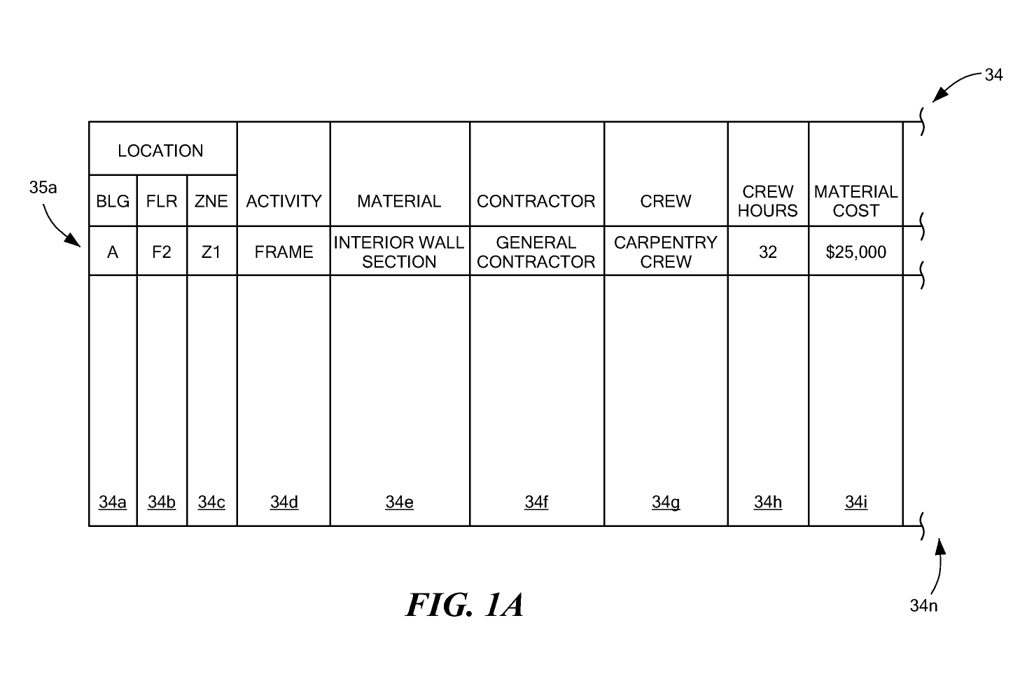

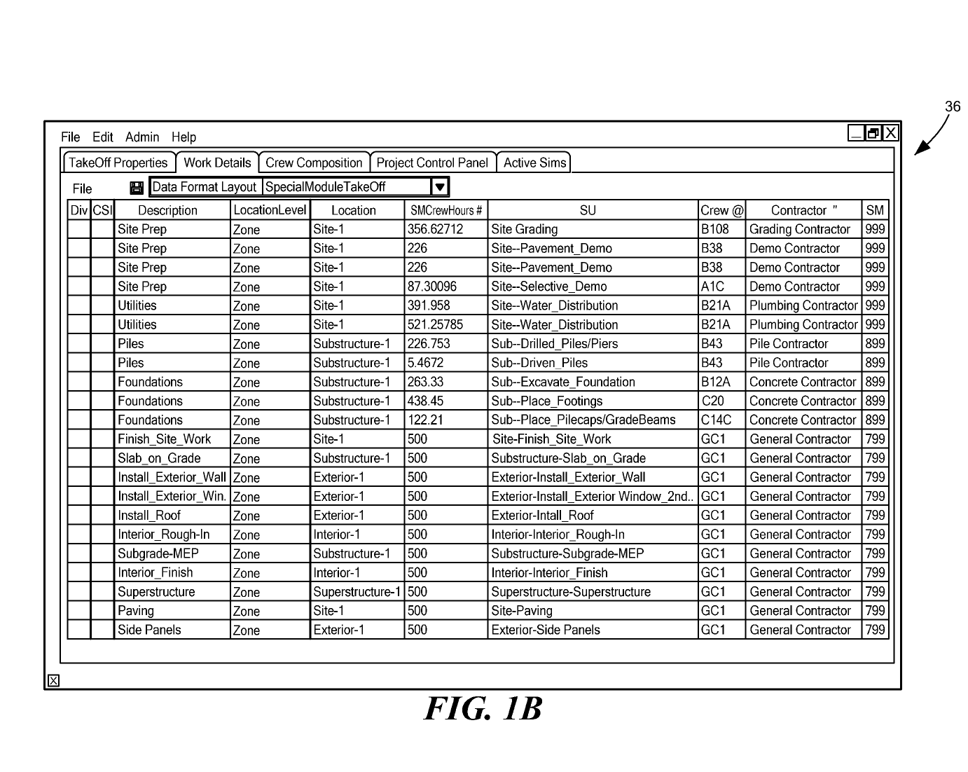

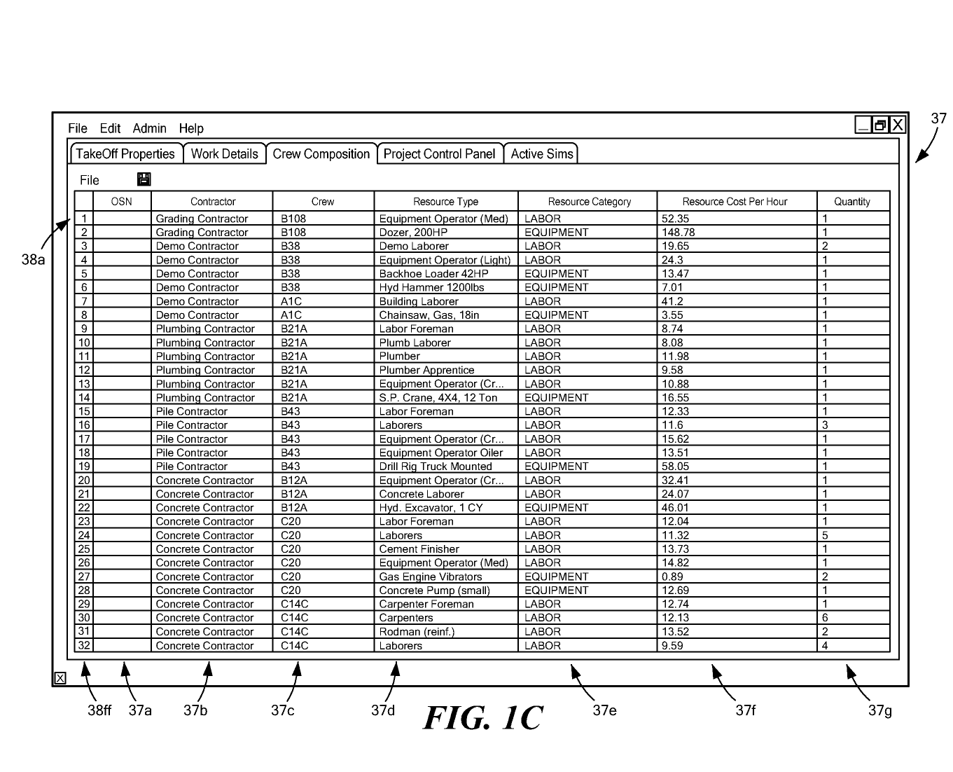

Referring now to FIG. 1, a simulation system 10 includes an input device 12a through which a user enters data through a user interface 14 and a data access layer 16 into a database 18. User interface 14 constructs a graphical and textual representation of data in database 18 and renders it to the user via an output device 12b. User interface 14 also collects input from a user via the input device 12a and uses that input to control the system and to query, insert, update, and delete data in database 18. Data access layer 16 represents a set of methods for querying, filtering, joining, inserting, updating, and deleting rows from database 18. These constitute a shared set of access methods used by user interface 14 and a schedule generator 22.

Database 18 has stored therein a plurality of tables which fully describe a project being simulated (e.g. which fully define a construction project). Database 18 includes a work details table 20 having a plurality of dimensional columns (with five dimensional columns D1-D5 being shown in FIG. 1) and a plurality of measure columns (with two measure columns M1, M2 being shown in FIG. 1).

A user enters data into the work details table (WDT) 20. Database 18 also includes a Crew Composition table 20a, a Precedence table 20b, a Resource Limits table 20c, a Project Schedule table 20d and a Calendar table 20e. These database tables are normally populated by the user except the Project Schedule table which is populated by the Schedule Generator component of the system 22 when initiated to do so by the user. The Precedence Table 20b is normally populated by the user by means of using the Precedence Editor 30. Similarly, other elements of the User Interface 14 may be used to populate the Crew Composition, Resource Limits and Calendar tables. Alternatively, data for these tables may be entered directly by the user (bypassing the User Interface) or copied from another database or from within the same database.

It should be appreciated that each project being simulated is a partition (i.e. a subset of the rows) of all the tables. The data associated with a single project can be used to generate (via push simulation and/or pull scheduling) one or more project schedules, each of which is stored as a set of rows of the Project Schedule table 20d. It should also be appreciated that other tables may also exist, but for clarity in the drawings and the description, only tables 20-20d are shown in FIG. 1. Practical systems include more tables than are shown in FIG. 1. The multi-dimensionality is represented by the fact that different projects are associated with different subsets of the dimensional columns of the Work Details table 20.

As mentioned above, schedule generator 22 is coupled to database 18 through data access layer 16. Schedule generator 22 has coupled thereto a pull processor 23 and a push processor 24. Push processor 24 comprises a simulation engine 25 which includes an event list 26, a scheduler 27, a simulation model 28 and a resource manager 29. The simulation model represents the data structure that is constructed out of precedence actors and work detail actors to be described below.

In accordance with one aspect of the techniques described herein, it is possible to add as many columns as desired to the work details table 20. This allows the project or portions of the project to be described in as fine detail or in as course a detail as desired and also allows change of locations, etc. . . . to be made. For example, different alternatives or strategies for assigning work to work crews may be used. For example, given two carpenter crews, it may be desirable to assign work such that one carpenter crew works on even numbered floors and the other carpenter crew works on odd number floors. However, it may instead be desirable to have both carpenter crews work on the same floor but have one crew work on the east side of the floor and the other crew work on the west side of the same floor. The different project schedules generated in these two cases describe alternative project plans, generated for purposes of comparison prior to selecting one plan or the other. It should be appreciated that typically in early design stages of a project tables 20-20d have fewer columns and rows than in later design stages of the project. This is because fewer project details are known earlier in the design stage than later. As a project progresses, more information is known allowing the database to be tailored as needed to accommodate project requirements.

For each simulation, the work details table 20 is populated with data from a customer (e.g. an owner or an architect) and/or data from a construction expert (e.g. a person skilled in identifying construction details, such as a number of work zones in a construction project). The WDT for a project thus includes a user-defined number of columns which number may be changed during a construction project to tailor the WDT 20 to meet the needs of the specific project simulation (the WDT is thus said to be configurable). It should be appreciated that both the number and meaning of the columns can change. By allowing configurable attributes in WDT 20, the WDT 20 is flexible which in turn provides flexibility in the model. This flexibility together with the fact that the Precedence and Resource Limits data refer only indirectly to data in WDT results in a high degree of data reusability in the system. The same or substantially similar Precedence and Resource Limits data can be reused from one project to another with only the WDT data being substantially different between the two projects.

As will become apparent from the description herein below, the work details, precedence data, resource limits data and crew composition data all are provided to a pull processor 23 and a push processor 24. The push and pull processors 23 and 24 write back scheduled data 20 into database table 20d.

A precedence editor 30 exists as part of user interface 14. Precedence editor 30 can be used to modify precedence data (i.e. modify a precedence relationship) and thus allows a user to define a sequence of work. For example, precedence editor 30 enables a user to define a set of rules describing constraints (e.g. logical constraints having physical meaning) which are to be satisfied (and preferably must be satisfied) by a schedule of the activities, including whether activities are to be push scheduled or pull scheduled. The attributes of a precedence relationship, for example, include whether its type is finish-to-start (FS), start-to-start (SS), or partial to start (PS). A FS precedence relationship is one in which the successor activity is allowed to start only after the predecessor activity has finished. Other types and attributes of precedence relationships may also exist.

Once the work details table having a user-defined number of columns is populated and precedences are defined to provide the precedence data, the project can be simulated via a simulation engine 25. It should be appreciated that schedule generator 22 receives precedence information in the form specified by the user and generates a detailed graph of precedence relationships between individual work details for use by simulation engine 25.

It should be appreciated that in preferred embodiments, the simulation system 10 does not utilize fixed predefined simulation models, rather each simulation model is dynamically assembled (i.e. the model is generated on the fly given the data). This is accomplished by reading the precedence graph data (e.g. the precedence relationships) together with the WDT and constructing a data flow graph of work detail actors and precedence actors which constitute the simulation model (see FIG. 1). It is, however, possible to utilize a fixed model in the system while still utilizing the pull processor. This approach, of course, limits the usefulness of the system as all customers then use the same set of attributes stored in database 18 and in work details table 20, in particular.

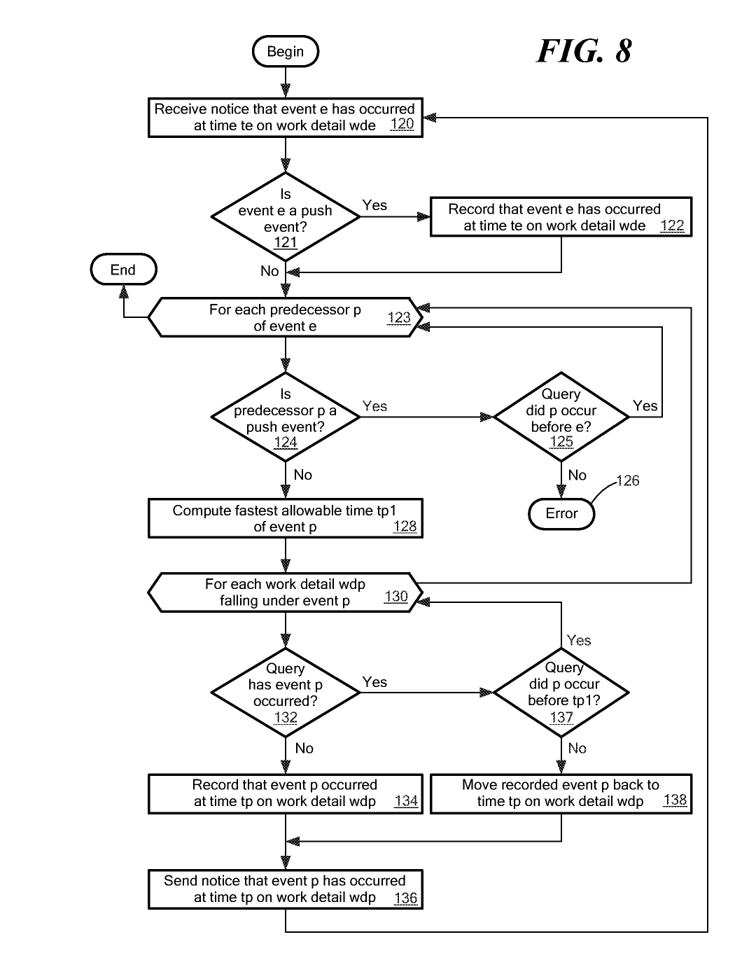

The push scheduling process is implemented with a simulation engine while the pull scheduling process is implemented with a JIT process (FIG. 8). The existence or presence of the pull processor in conjunction with the push processor allows so called “integrated master schedules” to be generated. Integrated master schedules include both push-schedule and pull-schedule activities which are related among themselves and to each other according to rules specified by the user in the precedence graph.

It should be noted that in the exemplary embodiment of FIG. 1, database 18 includes a plurality of separate tables 20-20d. In some embodiments, however, it may be desirable to provide each of the tables 20-20d as separate databases (e.g. separate relational databases).

Referring now to FIG. 1A, an exemplary work details table 34 includes a plurality of user-defined columns 34a-34N and a plurality of user-supplied rows 35a-35N. In the exemplary WDT 34 of FIG. 1A, columns 34a-34c contain building location data (e.g. a building, a floor and a zone). Column 34d identifies an activity to be performed at a designated location, while columns 34e-34i, respectively, specify materials, contractors, the type of crew needed to perform the work, the number of crew hours and the material cost. If more columns were required to further specify the project, then more columns could be added to table 34. The columns are all defined prior to running a simulation and typically the columns stay the same during the simulation.

Referring now to FIG. 1B, another work details table 36 is shown. In this example, the work details table includes a description column, a location level column, a crew hours column, an SLI column, a crew column, a contractor column and an SMPriority column. In this example, the user has chosen column names for some columns that have special meaning to the user (such as SLI for Schedule Line Item and SMPriority for Special Module Priority).

Referring now to FIG. 1C, an exemplary crew composition table 37 includes a plurality of columns 37a-37g and a plurality of rows 38a-38ff. In the exemplary table 37 of FIG. 1C, columns 37a contains a take-off serial number (TOSN), column 37b identifies a contractor, column 37c identifies a crew and columns 37d-37f, respectively, specify resource types, resource categories and resource cost per hour while columns 37g specify a quantity.

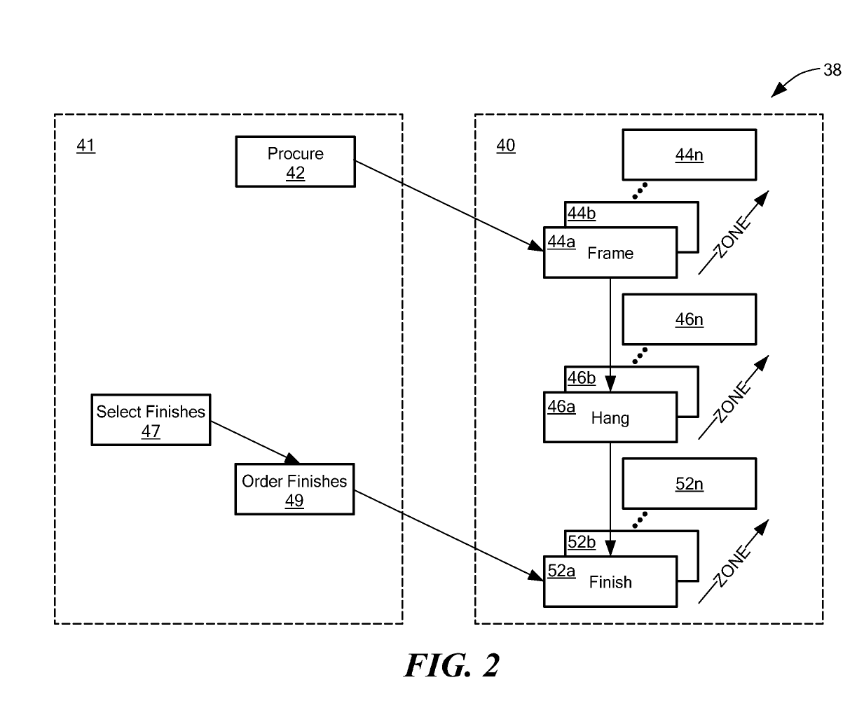

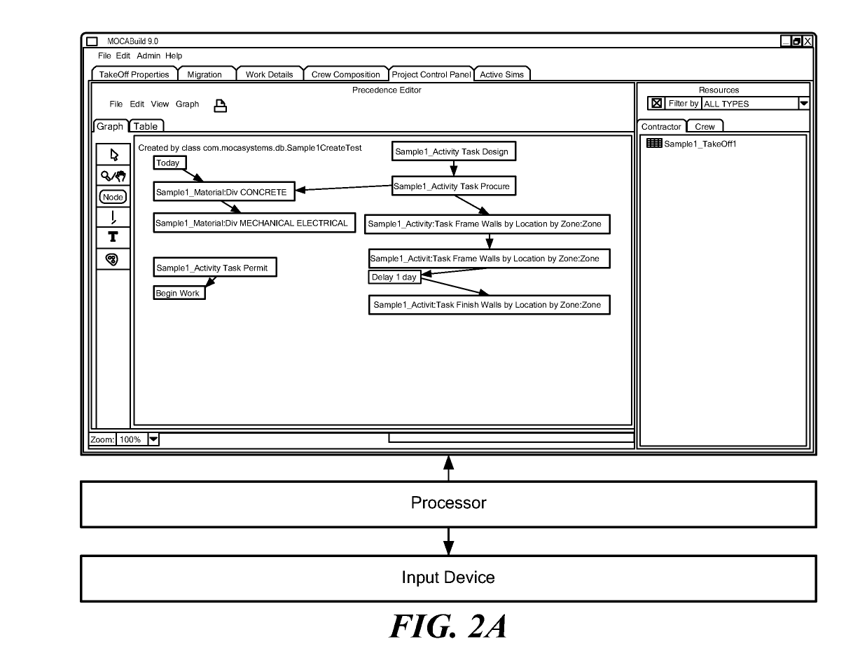

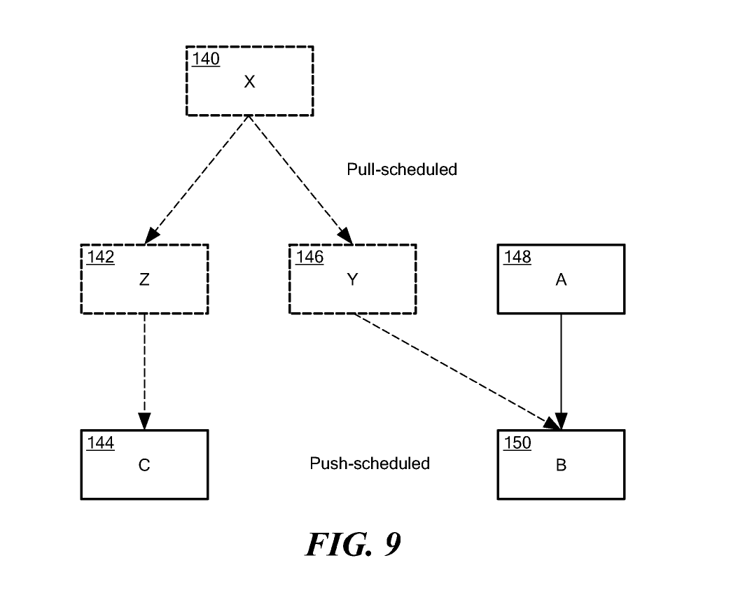

Referring now to FIG. 2, a precedence graph 38 includes a push portion 40 and a pull portion 41. The scheduling of pull portions of precedence graph 38 operate in accordance with a technique which is different than the technique with which push portions are scheduled. In particular, the push portions are said to be simulated (e.g. can be simulated via a discrete event simulator) while the pull portions are scheduled by a just-in-time process. That is, the system schedules all push activities by simulation and schedules all pull activities by a different technique to be explained below in conjunction with FIGS. 9-15. Thus, a simulation system (e.g. simulation system 10 in FIG. 1) uses two or more techniques for scheduling (i.e. at least one push technique and at least one pull technique).

It should be appreciated that blocks 44a-44n, 46a-46n, 52a-52n do not include duration information. The duration information is computed by the simulation system in accordance with the rules of the given scheduler. For example, a push scheduler (e.g. event scheduler 27 in FIG. 1) uses information such as available manpower, available materials and precedence constraints (e.g. the information stores in database 18 of FIG. 1) to calculate, among other things, duration.

It should also be appreciated that a single precedence graph can be used for multiple projects (e.g. multiple work detail tables) because it expresses rules about project activities in terms of the values of attributes of the work details in the project. Thus, a given node in a precedence graph might refer to a number of work details in one project but to a different number of work details, including possibly zero work details, in a different project.

It should also be appreciated that “frame” is a shorthand phrase for “frame walls” and that this is a possible value of the activity attribute or dimension of the work details. Thus, the Frame node (depicted as a stack of nodes 44a-44N) of the precedence graph refers indirectly to that set (possibly empty) of work details in the current project which have the value “frame walls” in the activity column. The total effort associated with these work details can only be determined by summing up the effort quantities of the corresponding work details, since there is no duration or effort information in the precedence graph itself.

Similarly, “hang (which is a shorthand phrase for “hang sheet rock”) is another possible value of the activity column of the work details table, and so the Hang precedence graph node (depicted as stack 46a-46N) refers indirectly to those work details having the value “hang sheet rock” in the activity column.

It should be appreciated that the precedence graph expresses rules about categories of activities by making indirect reference to specific work detail records. This allows a precedence graph to apply the same set of precedence rules to different sets of work details and hence to be reused both within a single project and between two projects. The arrow (directed arc) between Frame (44a) and Hang (46a) in FIG. 2 depicts that a precedence relation exists between all the “frame walls” work details and all the “hang sheet rock” work details. If the type of the precedence relation (not depicted) is FS, then this is a Finish-Start precedence relation. The stacked node depiction in FIG. 2 furthermore stipulates that this precedence relation is to be applied to a partitioning of the Frame and Hang work details by the Zone dimension, where the work details in each partition share a common value of the Zone attribute of the work details table. In summary, then, the Frame-arrow-Hang elements of FIG. 2 express the rule that all work details with a given value of the zone column and “frame” in the activity column must be finished before any work detail with that same value in the zone column and “hang” in the activity.

When this precedence rule is applied to work details in one project having values of Z1 and Z2 in the zone column, it expresses the rule: all work details with activity=“frame” and zone=“Z1” must be finished before any work detail with activity=“hang” and zone=“Z1” can start, and all work details with activity=“frame” and zone=“Z2” must be finished before any work detail with activity=“hang” and zone=“Z2” can start. When applied to work details in another project having “east” and “west” values in the zone, then the same precedence graph expresses the rule all work details with activity=“frame” and zone=“east” must be finished before any work detail with activity=“hang” and zone=“east” can start, and all work details with activity=“frame” and zone=“west” must be finished before any work detail with activity=“hang” and zone=“west” can start.

As illustrated in push portion 40 of FIG. 2, framing 44a, must be done prior to hanging sheet rock 46a which in turn must be done prior to finish work 52a (e.g. in terms of precedence framing must be done before hanging which must be done before finishing. However, pull events 43, 47 and 49 must also be taken into account. For example, as illustrated by block 43, materials must be procured prior to framing. Similarly, paint colors must be selected and paint must be ordered, as illustrated by blocks 47, 49, prior to finishing. Thus, the pull concept allows integrated project schedules to be generated (e.g. including possible project related activities of but not limited to, architects, designers, state officials, contractors or anyone else involved in the project).

Referring now to FIG. 2A, a graphical representation of user generated precedence data is shown (i.e. the figure corresponds to a visual representation of a user interface for a particular simulation project). It should be appreciated that FIGS. 2 and 2A illustrate two different ways to represent data (it should, however, also be appreciated that the same data is not represented in the two figures). The graphical representation may be displayed on a monitor (or other visual output device) having a processor and an input device coupled thereto with the processor implementing computer generated steps to require to compute and cause the user generated precedence data to be displayed on the visual output device.

Also, although not explicitly shown, those of ordinary skill in the art will appreciate that other attributes are implicitly included in the nodes and arcs in FIGS. 2 and 2A. For example, start-to-start, finish-to-start, partial completion, lag and the like are implicitly included in the nodes and arcs in FIGS. 2 and 2A.

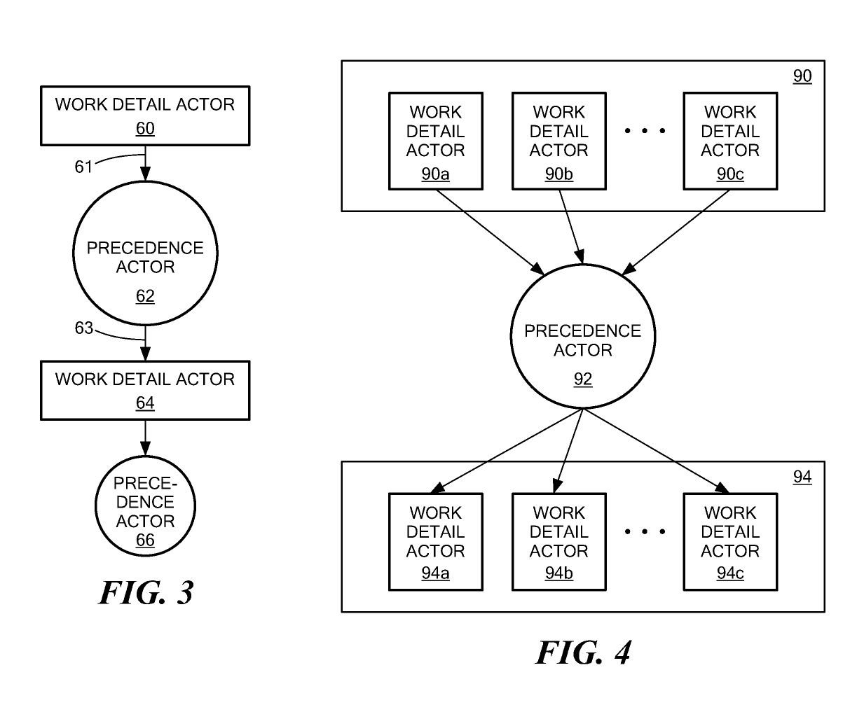

Referring now to FIG. 3 a data flow model (also sometime referred to as a data flow graph) comprised of a plurality of data flow operators 60-66. A simulation model typically includes a plurality of data flow operators each of which implements a process.

It should be appreciated that the data flow model includes two different types of data flow operators, namely: work detail actor (WDA) nodes (as evidenced by work detail actor nodes 60, 64) and precedence actor (PA) nodes (as evidenced by work precedence actor nodes 62, 66). WDA node 60 is connected via directed arc 61 to PA node 62. In turn, PA node 62 is connected via directed arc 63 to WDA node 64 which in turn is connected via directed arc 65 to PA node 66, where arcs 61, 63, 65 represent the flow of information among the nodes. Associated with each work detail is a calendar which describes when the resources involved in the work detail are available. When the WDA associated with the work detail requests an allocation of resources from the Resource Manager, the Resource Manager only allocates resources to the WDA on behalf of the work detail in accordance with the allowable work hours of those resource according to the calendar.

In one exemplary embodiment, suppose the precedence graph of FIG. 2 was applied to a WDT having no work details with activity=“hang” (this may occur because the project may involve the use of a new kind of pre-hung wall section, for example). For this case, it is desirable for finish activities to follow the frame activity even though there is no intervening hang activity. In this case, an empty work details actor is constructed to represent the absence of hang activities in each zone. Since the empty work details actor has no associated work detail, it immediately completes all of its activities as soon as it begins and then the precedence actor verifies that the order of frame precedes hang precedes finish in the zone is preserved since frame precedes finish in the zone.

Each of the PAs 62, 66 corresponds to an arrow illustrated in the precedence editor described above in conjunction with FIG. 2 (e.g. arrow 43 in FIG. 2). In practice, the PAs may be implemented as Java objects for example. It should be understood that not all actors are shown.

Referring now to FIG. 4 another data flow model includes a first plurality of WDAs 90a-90c, generally denoted 90, connected via directed arcs to a single PA 92. PA 92 is also connected, via directed arcs, to a second plurality of WDAs 94a-94c, generally denoted 94. Thus both WDAs and PAs can be in a one-to-many or a many-to-one relationship via directed arcs.

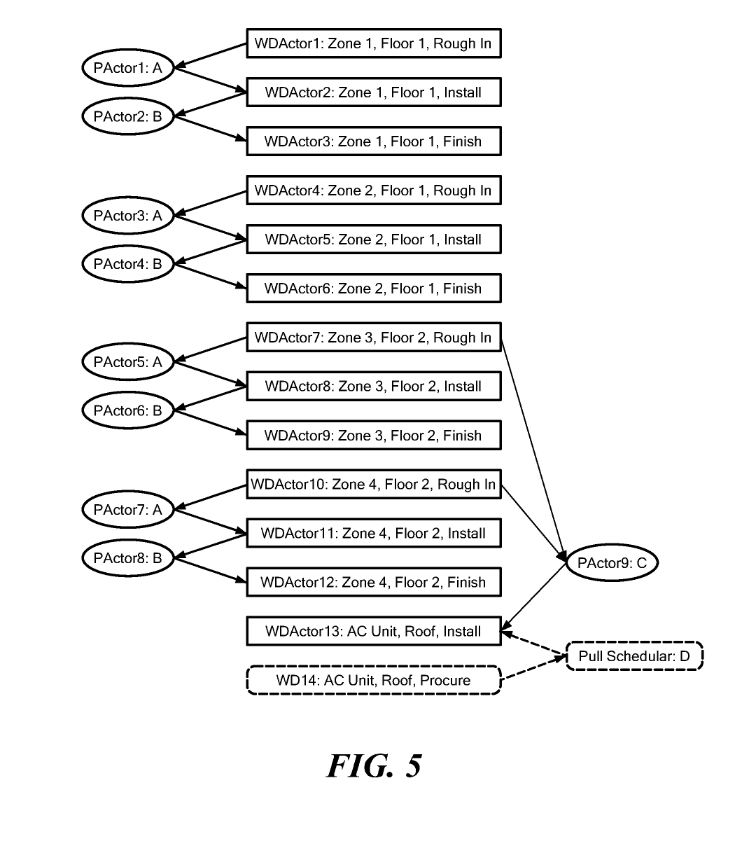

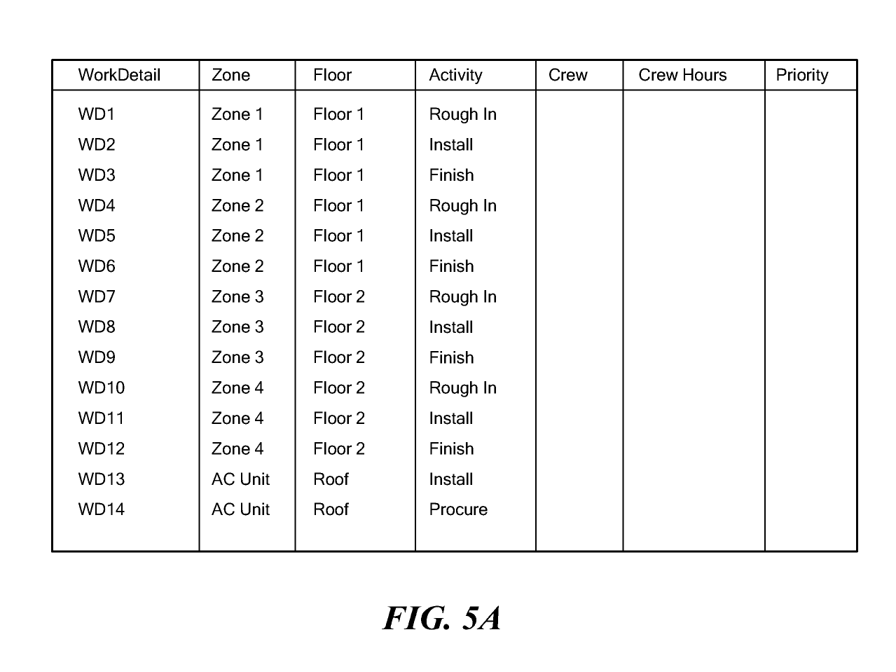

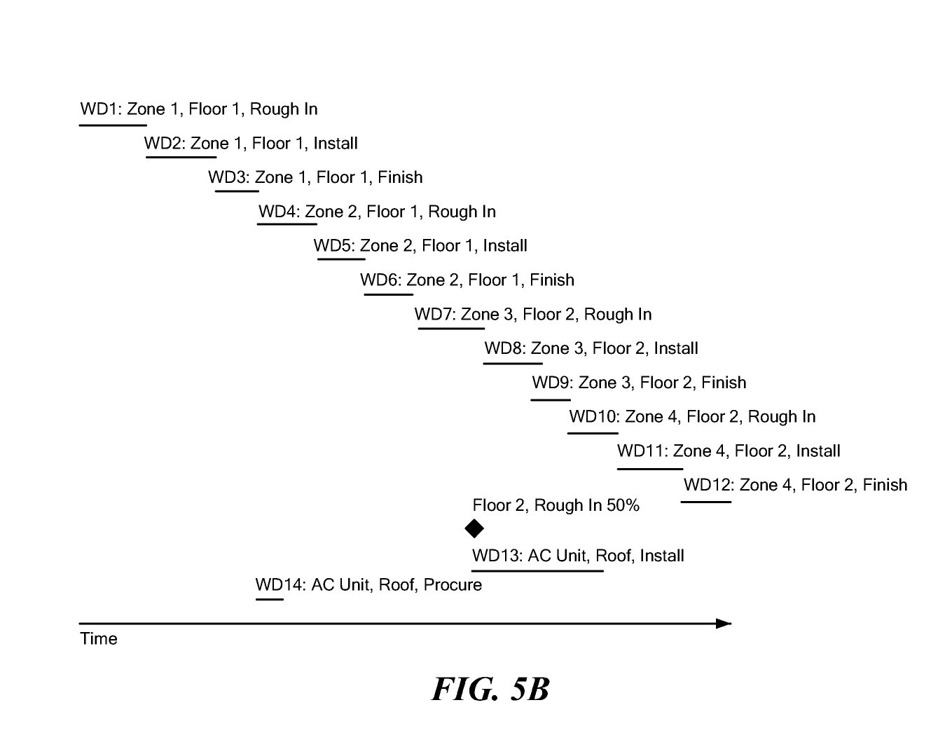

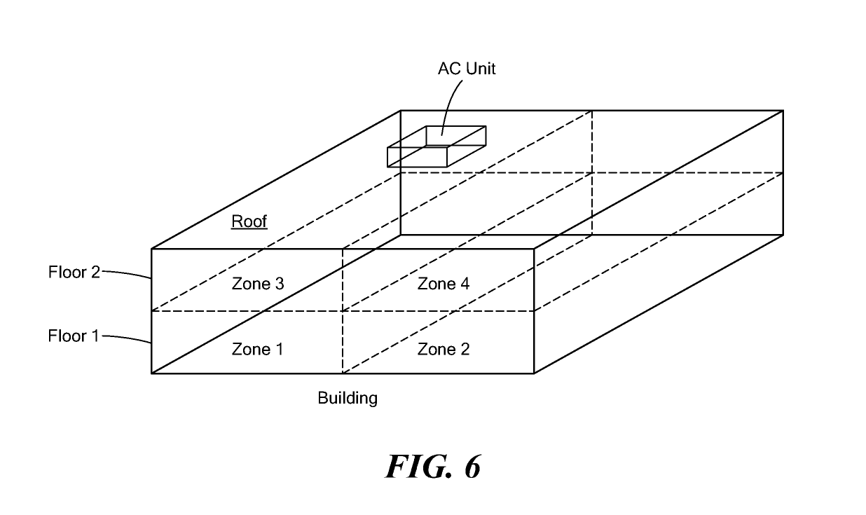

Referring now to FIGS. 5-7, described in conjunction with these figures is an exemplary construction project involving construction of a new HVAC system throughout a Building (shown in FIG. 6). The construction work includes RoughIn, Install, and Finish activities for all HVAC equipment and ductwork in four building Zones, and the Procurement and Installation of an AC Unit on a Roof of the Building. FIG. 6 is a wire frame drawing of the example building. The building is comprised of two floors, labeled Floor 1 and Floor 2 and a Roof. On the Roof of the Building is an AC Unit. Each Floor is comprised of two Zones. Zone 1 and Zone 2 are on Floor 1. Zone 3 and Zone 4 are on Floor 2.

FIG. 5A shows the WDT for this example project. For simplicity, the values of the Crew, Crew Hours, and Priority columns are omitted, although in a practical implementation, the values would be supplied.

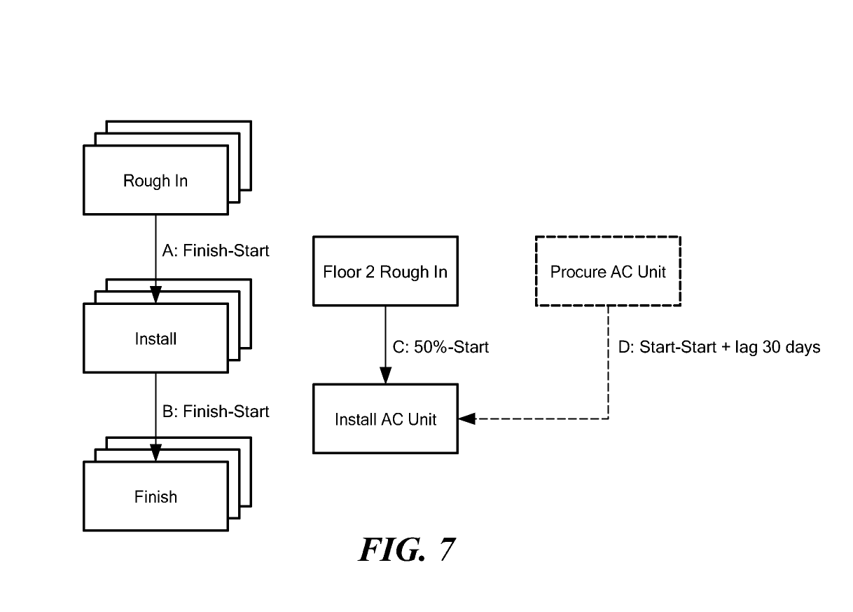

FIG. 7 shows the precedence graph for the project. The precedence rules expressed here are as follows. In each distinct Zone, (A) the RoughIn activity must be finished before the Install activity can start (as denoted by “A: Finish-Start” in FIG. 7). (B) the Install activity must be finished before the Finish activity can start (as denoted by “B: Finish-Start” in FIG. 7). (C) once 50% of all the RoughIn activity on Floor 2 has been completed, Install of the AC Unit can start (as denoted by “C: 50% Start” in FIG. 7). (D) the start of the Procure activity on the AC Unit must precede the start of Install of the AC Unit by 30 days (as denoted by “D: Start-Start+lag 30 days” in FIG. 7). The dotted line border on the Procure AC Unit precedence node and on the D arc signify that the scheduling of the Procure AC Unit activity is to be performed by the pull scheduler. All other activities (solid line borders) are to be scheduled by the push scheduler.

FIG. 5 shows the dataflow graph that is constructed to represent the Simulation Model (see FIG. 1) for this project, given the Work Details WD1-WD13 shown in the work details table of FIG. 5A and the Precedence Graph shown in FIG. 7. For each of the WorkDetails WD1-WD13, a corresponding WorkDetailActor is constructed (with the WorkDetailActor represented as rectangular boxes labeled WDActorl through WDActor13 in FIG. 5).

The precedence relation specified by the user in FIG. 7 and labeled A is enforced in the simulation model dataflow graph by each of the PrecedenceActors: PActor1, PActor3, PActor5, PActor7 (FIG. 5). Precedence relation B in FIG. 7 is enforced by dataflow operators PActor2, PActor4, PActor6, PActor8 in FIG. 5. PActor9 in FIG. 5 enforces the precedence relation C as shown in FIG. 7. Finally, the precedence relation D of FIG. 7 is enforced by the Pull Scheduler, shown in FIG. 5 with dotted line border.

In addition to the WorkDetails of FIG. 5A and the PrecedenceGraph of FIG. 7, we further assume that the user has specified a resource limit which states that not more than one labor Crew can be busy on a given Floor of the Building at any time. This resource limit is recorded in a Resource Limit table (such as resource limits table 20c shown in FIG. 1).

FIG. 5B then shows a representative Gantt chart of the Project Schedule as would be recorded in a project schedule table (such as project schedule table 20d of FIG. 1) and as it might be generated by the present system and technique. Within each Zone, the RoughIn, Install, and Finish activities are scheduled in “staircased” fashion relative to one another because of precedence relations A and B. The sequence of RoughIn-Install-Finish steps for each Zone are likewise staircased among themselves because of the resource contention caused by the Resource Limit that states that not more than one labor Crew can be busy on a Floor at a time. This resource limit is enforced by the Resource Manager in the Push Processor Simulation Engine (e.g. push processor simulation engine 25 in FIG. 1). The Resource Manager is also responsible for complying with any calendar of allowable work days and times which may be associated with a given work detail.

The order in which work on the individual floors proceeds is affected by the Priority values assigned to the corresponding WorkDetails. In FIG. 5, it can be seen that all Zone 1 WorkDetails have a higher Priority value than those of Zone 2, Zone 2 WorkDetails in turn have a higher Priority value than those of Zone 3, and Zone 3 WorkDetails have a higher Priority value than those of Zone 4.

Precedence relations A and B, the stated Resource Limit and the Priorities assigned to WorkDetails together all result in the staircasing of WorkDetail activities WD1 through WD12 as seen in FIG. 5B.

PActor9 of FIG. 5 records the milestone “Floor 2, RoughIn 50%” when it detects that 50% of all the RoughIn activity on Floor 2 has been completed.

In the example, we see that WD7 and WD10 are the only WorkDetails which describe RoughIn activity on Floor 2, and WD7 includes somewhat greater CrewHours of effort than does WD10. This is evidenced by the WD7 Gantt bar being slightly longer that the WD10 Gantt bar in FIG. 5B. Therefore, 50% of the combined work is completed just prior to the completion of WD7. By precedence relation C, the “Floor 2, RoughIn 50%” milestone allows WD13 work to start. Finally, once the start time of WD13 is known, the Pull Scheduler is notified and then schedules the WD14 predecessor activity to begin 30 days prior to this, as shown by the WD14 Gantt bar in FIG. 5B (i.e. the Pull Scheduler schedules the WorkDetail WD14 upon notification from WDActorl 3 that WorkDetail WD13 has started).

FIG. 8 is a flow diagram showing the processing performed by a simulation system to simulate a project (e.g. a construction project). In particular, FIG. 8 is a flow diagram which describes the recording of project schedule data and it illustrates pull scheduling (i.e. FIG. 8 includes some logic implemented in the pull processor and some logic implemented in the schedule generator). When the push processor is running, it invokes the logic of FIG. 8 by having the schedule processor invoke it.

The rectangular elements (typified by element 120 in FIG. 8), are herein denoted “processing blocks” and represent computer software instructions or groups of instructions. The diamond shaped elements (typified by element 121 in FIG. 8) are herein denoted “decision blocks” and represent computer software instructions, or groups of instructions which affect the execution of the computer software instructions represented by the processing blocks. It should be noted that the flow diagram of FIG. 8 represents one embodiment of the design and variations in such a diagram, which generally follow the process outlined are considered to be within the scope of the concepts and techniques described and claimed herein.

Alternatively, the processing and decision blocks can represent operations performed by functionally equivalent circuits such as a digital signal processor circuit or an application specific integrated circuit (ASIC) of a field programmable gate array (FPGA). The flow diagrams do not depict the syntax of any particular programming language. Rather, the flow diagrams illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence described is illustrative only and can be varied without departing from the spirit of the concepts described and/or claimed herein. Thus, unless otherwise stated, the processes described below are unordered meaning that, when possible, the sequences shown in FIG. 8 can be performed in any convenient or desirable order.

Turning now to FIG. 8, processing begins in processing block 120 in which notice is received from the push processor that event “e” has occurred at time “tₑ” on a work detail “WDₑ.” Processing then proceeds to decision block 121 in which a decision is made as to whether event e is a push event. If a decision is made that event e is a push event, then processing flows to processing block 122 in which it is recorded in the schedule table (FIG. 1) that event e occurred at time to on work detail WDₑ. This makes the data persistent so that it can be referred to later in time. Processing then flows to processing block 123. If in decision block 121, a decision is made that event e is not a push event, then processing flows directly to processing block 123.

Processing block 123 and decision blocks 124, 125 implement a loop to determine whether each predecessor event p occurred prior to event e. In decision block 124, a decision is made as to whether each predecessor p is a push event. If a decision is made that event p is a push event, then processing flows to decision block 125 in which it is determined whether event p occurred prior to event e.

If, in decision block 124 a decision is made that predecessor p is not a push event, then processing directly flows to processing block 128 in which the latest allowable time tₚ₁ of event p is computed.

Processing then flows to processing block 130 and decision blocks 132, 133 which implement a loop to determine whether event p has occurred and if so, whether event p occurred before time tₚ₁. If event p has not occurred, then processing flows to processing block 134 in which it is recorded that event p occurred at time tₚ on work detail WDₚ. Processing then proceeds to processing block 136 in which notice is sent that event p has occurred at time tₚ on work detail WDₚ.

If, in decision blocks 132, 137 a decision is made that event p occurred, but not before time tₚ₁, then processing flows to processing block 138 in which recorded event p is moved back to time tₚ on work detail WDₚ. Processing again proceeds to processing block 136 in which notice is sent that event p has occurred at time tₚ on work detail WDₚ. A new call stack frame is pushed on the processing stack and processing then flows recursively back to processing block 120 and the process is repeated. When loop 123 completes, processing terminates at block 139. The call stack is popped and if a previous stack frame exists, it continues processing at loop 130. When all iterations of loop 130 have completed, processing continues at block 123

Error conditions at block 126 occur when conditions such as that shown in FIG. 14 occur (e.g. a push followed by a pull followed by a push).

FIGS. 9-15 describe a concept and techniques referred to as pull scheduling.

The kind of scheduling that the Simulation Engine (e.g. simulation engine 25 of FIG. 1) performs is called push scheduling, because it infers the earliest completion dates of activities described in the work details subject to initial constraints and the constraints of resource availability and precedence.

A pull schedule in contrast, determines the latest (e.g. “just-in-time” or JIT) start times for a set of activities given a set of final precedence constraints.

When a Master Integrated Schedule (MIS) is traditionally constructed, the usual process is to first generate the push schedule. This typically describes the on-site construction project. Then holding the push schedule fixed, the pull schedule is deduced by reasoning temporally backwards to determine the latest dates at which certain prerequisite activities must have occurred given the dates of the push activities and given the precedence constraints among the pull activities. The pull activities typically describe off-site activities like procurement, permitting, and design.

The present invention implements pull scheduling in conjunction with the normal simulation driven push scheduling, making it possible to generate an MIS entirely by automated means.

The user constructs the precedence graph for a project to describe both the push and pull precedence rules. Work detail records are supplied both to describe the work performed in push activities and that performed in pull activities. Whether a work detail is to be schedule by the push or by the pull processor is determined by an specified by the user in each node of the precedence graph. As with traditional push activities, there need not be work details present that fall under all Precedence nodes. The PrecedenceGraph can describe more rules than need to be enforced by the current set of work detail records. This supports the reusability of the precedence graph across projects.

Each WorkDetail record for a pull activity is interpreted as a fixed duration activity where the CrewHours value alone determines the length of the activity. If the user supplies two WorkDetail records that fall under a given pull precedence node, then each such WorkDetail corresponds to a separate pull activity (so the user has manual control over parallel pull activities if desired).

The user explicitly indicates in the PrecedenceGraph (e.g. see FIGS. 2 and 2A) which activities if any are to be pull-scheduled. The remainder are push-scheduled. If a WorkDetail falls under some pull-scheduled precedence node, then it is a pull-scheduled WorkDetail. All remaining WorkDetails are push-scheduled. If some WorkDetail falls under both a pull and a push precedence node, then it is excluded from push-scheduling and is adjudicated to be pull scheduled. Any WorkDetail that falls under a no precedence node is push-scheduled.

The simulation process runs normally, operating only on the subset of WorkDetails that are not pull-scheduled, and obeying only push precedence rules. Resource limits apply only to push scheduled activities. As the simulation runs, pull scheduling automatically records the pull-scheduled events which must have occurred in order to satisfy each push-scheduled one. If a pull-scheduled event has already been recorded as a result of an earlier push event, then the pull-scheduled event is updated if necessary with earlier start and end times to accommodate all simulated push events and still maintain pull precedence rules. This readjustment and recording of the start and end times of pull scheduled events is accomplished by the process depicted in FIG. 8 and described above.

When the simulation completes, if any pull activities exist which have non-zero associated WorkDetails and which have not been scheduled by some push event, then an error condition occurs which results in a reporting that the schedules for these activities have been underspecified. The user expresses precedence relations on these activities in the precedence graph in order to achieve an error-free simulation run. It would be sufficient for instance, to relate them to some date or to an event which occurs when the simulation ends (such as an implicit “End Of Project” milestone).

To reiterate, the user constructs and edits a PrecedenceGraph or copies one from another project in the database. Some portion of the precedence graph represents push-scheduled activities and some portion represents activities which are to be pull scheduled (i.e. lead-time activated activities). The user connects nodes in the precedence graph to indicate precedence constraints within that portion and also connects nodes in the pull portion of the graph to nodes in the push portion, indicating where the interface points are between the push (simulated) and pull (e.g. just-in-time) portions of the schedule.

Precedence nodes and arcs are used identically in the pull and push portions of the graph. Since all precedence rules are considered push by default, the user explicitly indicates when nodes are to be made pull. This is done by selecting one or more nodes and setting them to be pull, or by choosing this setting in the properties dialog of an individual node. The pull/push indicator is similar to a color attribute except that it has only two possible values. The PrecedenceEditor visually differentiates the pull and push parts of the graph.

Referring now to FIG. 9, consider the following portion of a precedence graph, where pull and push elements are distinguished, respectively, by dashed and solid lines.

Here the nodes A, B, and C refer indirectly to push scheduled (simulated) activities in the work details of the project and X, Y, and Z refer to pull-calculated activities of those work details. The B activity might be Install AHUs and the prerequisite pull Y and X activities might be Order AHUs and Design AHUs, for example.

Precedence nodes are all defined the usual way, namely associated with each is a predicate which selects a subset of WorkDetails. Here it is assumed that the Precedence nodes select values of a column of the work details table which names an activity as indicated.

The simulation runs under the direction of the push processor (see FIG. 1). When the schedule generator is notified that work begins on a given push-scheduled WorkDetail, the simulated event is recorded as usual, and then the interface checks to see if any pull-scheduled precedence has been declared on the given WorkDetail successor. If not, the simulation continues normally.

If pull precedence exists, however, the prerequisite pull activities are automatically either recorded for the first time or modified by pushing them backwards in time as necessary to accommodate the new successor event. This same logic is repeated for each recorded simulation event. The result is that the inferred pull activities all just-in-time satisfy both successor push events and successor pull events. This pull scheduling process is depicted in greater detail in FIG. 8, already described.

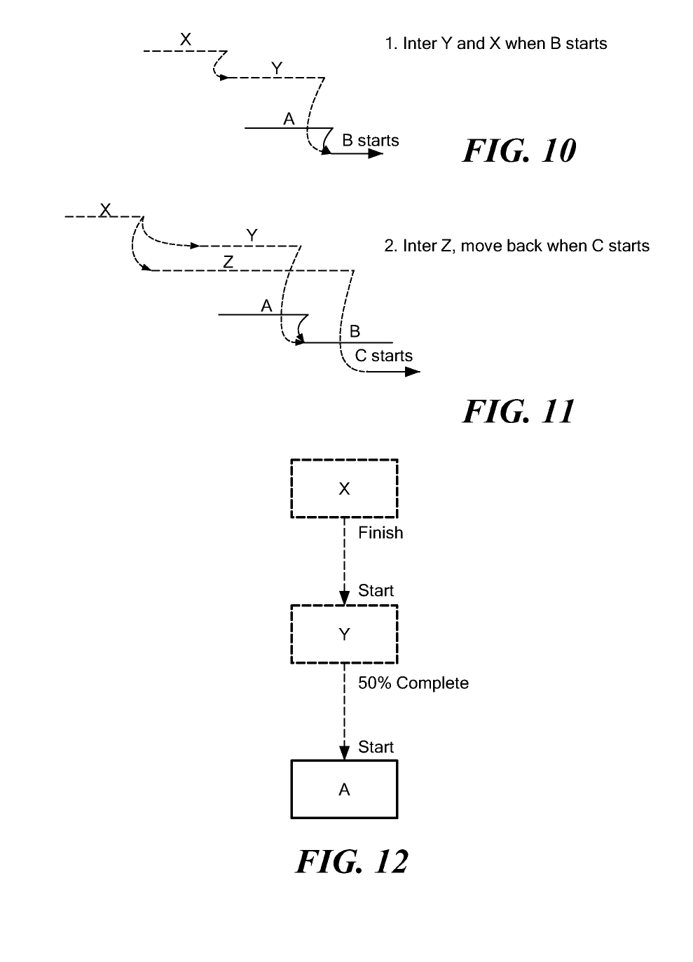

Referring now to FIGS. 10 and 11, we consider the schedule generated to satisfy the example precedence depicted in FIG. 9.

First, pull precedence Y and then X are inferred as soon as B is detected to start. Using the start time of B and the CrewHours of the WorkDetails falling under Y and X, the start of Y, end of X and start of X times are determined by date subtraction. Every pull predecessor of B must be examined (there might be more than one), and every pull predecessor of a pull predecessor must be examined as well. For each such pull predecessor, each WorkDetail falling under it results in a separate activity being recorded. If any pull predecessor does not yet have a recorded activity, then we create one, as for Y and X in FIG. 10.

If a pull predecessor activity has already been recorded, then we check to see if its end date satisfies the given successor. If not, then we update the predecessor activity in place to move it back until it just does so. So in FIG. 11, where we detect that push successor C has started, we infer the existence of pull predecessor Z, and then determine that X must be moved back to accommodate. Activity Y is not on C's predecessor path and hence requires no adjustment.

Notice that any resource limits that might otherwise apply to the resources of the pull-scheduled activities are ignored. Nothing prevents the pull-scheduled activities from overlapping with concurrent push-scheduled activities and using the same resources. It is expected that pull-scheduled resources will generally use resource pools distinct from the push-scheduled resource pools, however. In this case the resource levels required by the pull-scheduled activities will be inferred from the pull schedule rather than imposed upon it.

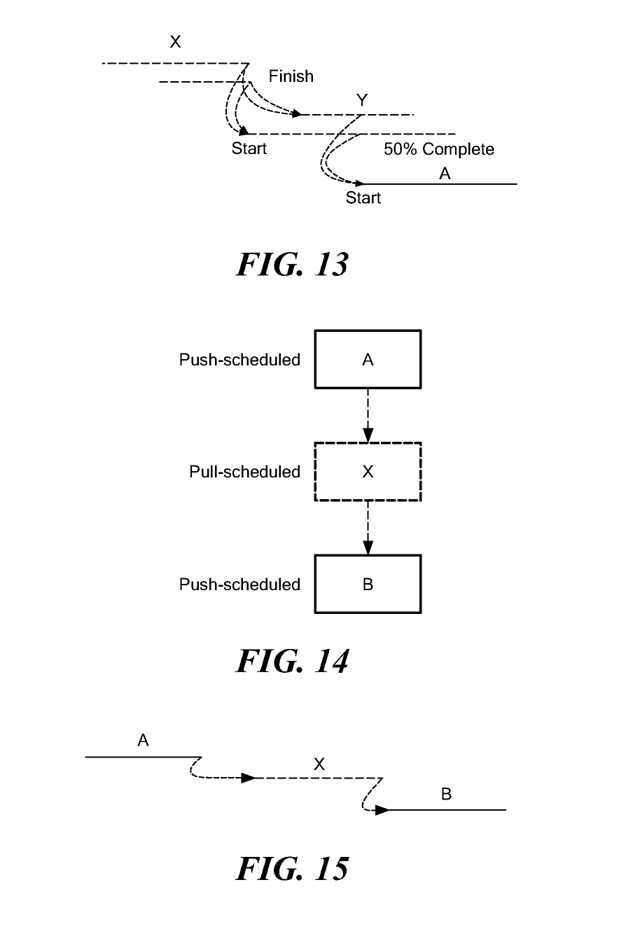

Referring now to FIG. 12, if there are multiple WorkDetails falling under a pull-scheduled precedence node, then each such WorkDetail is individually pull-scheduled by the above-described pull schedule process. That is to say, the WorkDetails are not scheduled together as a collection. Thus, suppose X and Y are pull-scheduled to precede A as shown in FIG. 12 and if X and Y each have multiple WorkDetails of unequal sizes, we might have pull-scheduled results as shown in FIG. 13 where the beginning of each work detail falling under Y is individually scheduled so that WorkDetail will be fifty percent (50%) complete when A begins).

Referring now to FIG. 14, it should be noted that some pull-scheduled activity might eventually have a push-scheduled predecessor, e.g. a precedence milestone Date node, or some simulated event. In other words some pull-scheduled activities might be embedded between push-scheduled predecessors and successors.

Push-scheduled events and milestone dates cannot in general have their start and finish time modified without affecting other simulated events unpredictably. Therefore it is possible that the push-scheduled predecessor will cause a simulation runtime error. This would happen if the fixed length pull-scheduled events are found to not all fit inside the push-scheduled window described by the user's precedence rules. However, if the pull-scheduled activities fit within the push-constrained window of opportunity, the result might be as shown in FIG. 15

Another aspect of the feature design is that the user can easily choose to push-schedule any portion of what are normally thought of as pull-scheduled activities. This brings all the capabilities of the simulation model to bear on developing a sub-schedule for procurement and design type activities if resource contention needs to be modeled for these activities.

Specially identified BeginSim and EndSim precedence nodes (i.e. nodes which define either a beginning of a simulation or an end or a simulation, respectively) may be placed in the precedence graph by the user. These behave like push-scheduled milestone dates which automatically receive their date value from the first or last occurrence, respectively, of simulated allocation activity. There can be any number of BeginSim or EndSim nodes in a precedence graph, all BeginSims have the same meaning and occur simultaneously with the first simulation activity. All EndSims likewise occur simultaneously with the last simulation activity.

Implicitly, all push-schedule activities succeed BeginSim and precede EndSim. Therefore the user is not allowed to directly connect any push-scheduled activities to them, nor can pull-scheduled activities be connected as successors to them. However, pull-scheduled nodes can be related to precede either a BeginSim or an EndSim.

This provides a convenient mechanism for pull-scheduling activities to be completed by the start of the first or finish of the last push-scheduled activity, without needing to know which push-scheduled activities happen to occur first or last for a given Simulated schedule. This mechanism will, in fact, be necessary for planning such pull scheduled activities in some cases, because the identity of the first-starting and last finishing activities are usually not known when the precedence graph is composed. Their identity is only known after the push processor finishes simulating.

In view of the above description, it should now be appreciated that there exists a need to improve the reusability of the data and logic governing complex project schedules and to reduce the costs of defining complex project schedules by prior methods and systems, especially for large and complex projects like construction projects.

All publications and references cited herein are expressly incorporated herein by reference in their entirety.

In the figures of this application, in some instances, a plurality of elements may be shown as illustrative of a particular element, and a single element may be shown as illustrative of a plurality of the particular element. Showing a plurality of a particular element or step is not intended to imply that a system or method implemented in accordance with the concepts, structures and techniques described herein must comprise more than one of that element or step. Nor is it intended by illustrating a single element that the concepts, structures and techniques are limited to embodiments having only a single one of that respective element. Those skilled in the art will recognize that the numbers of a particular element shown in a drawing can be, in at least some instances, selected to accommodate the particular user needs.

It is intended that the particular combinations of elements and features in the above-detailed embodiments be considered exemplary only; the interchanging and substitution of these teachings with other teachings in this and the incorporated-by-reference patents and applications are also expressly contemplated. As those of ordinary skill in the art will recognize, variations, modifications, and other implementations of what is described herein can occur to those of ordinary skill in the art without departing from the spirit and scope of the concepts as described and claimed herein. Thus, the foregoing description is by way of example only and is not intended to be and should not be construed in any way to be limiting.

Further, in describing the concepts, structures and techniques and in illustrating embodiments of the concepts in the figures, specific terminology, numbers, dimensions, materials, etc., are used for the sake of clarity. However the concepts, structures and techniques described herein are not limited to the specific terms, numbers, dimensions, materials, etc. so selected, and each specific term, number, dimension, material, etc., at least includes all technical and functional equivalents that operate in a similar manner to accomplish a similar purpose. Use of a given word, phrase, number, dimension, material, language terminology, product brand, etc. is intended to include all grammatical, literal, scientific, technical, and functional equivalents. The terminology used herein is solely for the purpose of description and should not be construed as limiting the scope of that which is claimed herein.

Having described the preferred embodiments of the concepts sought to be protected, it will now become apparent to one of ordinary skill in the art that other embodiments incorporating the concepts may be used. Moreover, those of ordinary skill in the art will appreciate that the embodiments of the invention described herein can be modified to accommodate and/or comply with changes and improvements in the applicable technology and standards referred to herein. For example, the technology can be implemented in many other, different, forms, and in many different environments, and the technology disclosed herein can be used in combination with other technologies. Variations, modifications, and other implementations of what is described herein can occur to those of ordinary skill in the art without departing from the spirit and the scope of the concepts as described and claimed. It is felt, therefore, that the scope of protection should not be limited to or by the disclosed embodiments, but rather, should be limited only by the spirit and scope of the appended claims.

What is claimed is:

1. In a processor, a method of simulating a project comprising:
storing in a storage device, a work details table having a user-determined number of columns with each of the columns having a user-defined meaning;
defining precedence constraints in a precedence graph;
populating the work details table with data; and
generating a schedule for the project via a simulation engine and a pull processor.

2. The method of claim 1 wherein the precedence constraints refer to attributes of the work details.

3. The method of claim 1 wherein defining precedences comprises defining for each node a row or group of zero or more rows in the work details table to which the node refers.

4. The method of claim 1 further comprising storing, in the storage device, a resource limits table having a user-determined set of resource limits

5. The method of claim 1 wherein populating the work details table with data comprises populating the work details table with data from a customer and/or populating the work details table with data from an expert.

6. The method of claim 1 wherein storing work details table in a storage device comprises storing a plurality of work details tables in a database.

7. The method of claim 1 wherein simulating the project via a simulation engine comprises:
generating a model for the project;
setting a simulation time to a date which defines a start date;
running a simulation and advancing the simulation time wherein the advanced simulation time applies to the entire model; and
maintaining a list of events in chronological order, each of which refers to a simulated time and an actor.

8. The method of claim 7 wherein generating a model for the project comprises building the model with a plurality of nodes connected via directed arcs to provide a project specific data flow graph.

9. The method of claim 8 wherein at least one of the plurality of nodes corresponds to a work detail actor and at least one of the plurality of nodes corresponds to a precedence actor.

10. The method of claim 8 wherein the plurality of nodes is implemented as a plurality of software objects.

11. The method of claim 9 wherein a calendar is associated with each work detail.

12. The method of claim 1 further comprising editing the precedence graph.

13. The method of claim 12 further comprising placing BeginSim and EndSim precedence nodes in the precedence graph

14. The method of claim 13 wherein the BeginSim and EndSim precedence nodes behave like push-scheduled milestone dates which automatically receive their date value from a first simulated allocation activity and a last simulated allocation activity, respectively.

15. The method of claim 13 wherein pull-scheduled nodes can be related to precede either a beginning of a simulation or an end or a simulation.

16. The method of claim 12 where attributes of precedence constraints can be edited.
